(19) United States
(12) Patent Application Publication
(10) Pub. No.: US 2003/0146149 A1
(43) Pub. Date: Aug. 7, 2003

(54) Filter element suitable for filtering liquids

(75) Inventors: Walter Binder, Backnang (DE); Helmut Luka, Marbach (DE); Norbert Strassenberger, Adlkofen (DE); Gerhard Vilsmaier, Unterdietfurt (DE); Matthaeus Huber, Reisbach (DE); Renate Gottwald-Grill, Bietigheim-Bissingen (DE)

Correspondence Address: CROWELL & MORING LLP, INTELLECTUAL PROPERTY GROUP, P.O. BOX 14300, WASHINGTON, DC, 20044-4300, US

(73) Assignee: Filterwerk Mann & Hummel GmbH, Ludwigsburg (DE)

(21) Appl. No.: 10/278,016

(22) Filed: Oct. 23, 2002

(30) Foreign Application Priority Data
Oct. 24, 2001 (DE) 101 52 552.4

(51) Int. Cl. B01D 29/00

(52) U.S. Cl. 210/497.01

(57) ABSTRACT

A filter element including an annular support body, a filter medium, which is preferably a filter paper folded in a zigzag shape, positioned on the annular support body, and end disks, which are positioned on the axial end faces of the filter medium and glued or welded to the filter medium. The filter element is characterized in that a seal carrier is provided on the support body in the vicinity of one or both end disks, and a seal, particularly an elastomer seal, is affixed to the seal carrier in an interlocking manner. The seal carrier is designed to be radially elastic. The filter of the invention is particularly suitable for filtering liquids.

### BACKGROUND OF THE INVENTION

The present invention relates to a filter element, particularly for the filtration of liquids, and to a filter system utilizing such a filter element.

United Kingdom Patent No. GB 2,119,674 discloses a filter element comprising a supporting body upon which a filter medium folded in a zigzag shape is positioned. The axial end faces of the filter medium are closed off by end disks, and rubber profiled seals are positioned on the end disks. A disadvantage of this arrangement is that the profiled seals may only produce a slight tolerance compensation, and reliable sealing is not assured in the event of improper installation or large tolerances of the housing.

Furthermore, U.S. Pat. No. 5,556,440 discloses a filter system comprising a seal which also is constructed as a profiled seal and is integrated directly into the end disks. The sealing forces of this radial seal act directly on the filter medium and, in certain circumstances, may cause tearing or detachment of the end disks.

To avoid such unintended destruction, U.S. Pat. No. 5,484,466 proposes implementing the sealing profile of the end disks so elastically that sufficient clearance for deflection of the seal is provided. However, this leads to the selected sealing profile having to bridge a very large distance and, in certain circumstances, the filter element is not sufficiently centered in a housing.

U.S. Pat. No. 5,685,985 discloses a further filter element sealing structure comprising a radial seal which extends in the axial direction over the filter element and presses against a sealing ring. However, in the case of this seal, there is a danger that the relatively labile seal will not be able to assure that filter element will be properly centered.

### SUMMARY OF THE INVENTION

It is therefore an object of the present invention to provide an improved filter element which assures a reliable seal between an unfiltered fluid region and a filtered fluid region.

A further object of the invention is to provide a filter element with a radial seal which is particularly suitable for filtering liquids.

Another object of the invention is to provide an improved filter system which utilized the filter element of the invention.

These and other objects are achieved in accordance with the present invention by providing a filter element comprising an annular support body, a filter medium positioned on the annular support body, a pair of end disks each positioned on a respective end face of the filter medium and attached to the filter medium, and at least one seal carrier on the support body in the vicinity of a respective one of said end disks, said seal carrier being radially elastic and having a seal affixed thereto in an interlocking manner.

In accordance with a further aspect of the invention, the objects also are achieved by providing a fluid filter system comprising a filter housing, an inlet for unfiltered fluid, an outlet for clean fluid, a connection sleeve positioned on the clean fluid outlet, and a filter element removably attached to the connection sleeve and positioned in the filter housing such that fluid must flow through the filter element to pass from said inlet to said outlet; wherein at least one radially elastic seal carrier is provided on the support body in the vicinity of a respective one of the end disks, said seal carrier having a seal attached thereto in an interlocking manner, and wherein the seal carrier is radially elastic.

The filter element of the invention has the advantage that a seal carrier is provided on the supporting body in the vicinty of one or both end disks. The seal carrier is designed to be radially elastic or resilient and supports a seal, particularly an elastomer seal, joined thereto in an interlocking manner. As a result of this design, the elasticity or resilience of the seal is increased, but reliable fixation of the filter element is nevertheless assured.

According to one embodiment, the seal carrier comprises two intermeshing tongues, which each can pivot from one side. The elastomer seal is connected to the support body via these tongues. The tongues have spring properties which allow the seal to yield.

In an alternative embodiment, the seal carrier is designed as a membrane. Higher elasticity of the sealing system is also assured by this construction.

In accordance with a preferred refinement of the invention, the seal is provided with a region capable of axial sealing, so that, in addition to achieving proper radial fixation, the axial position of the filter element may also be fixed.

In one preferred embodiment of the invention, the end disks are produced from nitrile rubber. This material has high resistance to temperature and aging and is easy to process. Both the end face of the filter medium and the end face of the support body may be enclosed and sealed using this nitrile rubber.

Furthermore, the present invention relates to a filter system, particularly a system for the filtration of liquids. This system comprises a filter housing, an inlet for the unfiltered liquid, an outlet for the clean liquid, and a filter element positioned in the filter housing. The filter element also has a radially elastic seal carrier, on which the seal is positioned in an interlocking manner. The filter element is removably attached to a connecting sleeve which is located on the clean liquid outlet.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawings in which:

FIGS. 1a, 1b and 1c show different variants of a sealing system according to the invention;

FIGS. 2a and 2b show further variants of a sealing system according to the invention,

FIGS. 3a, 3b and 3c show another series of variants of a sealing system according to the invention, and

FIG. 4 shows a complete filter system according to the invention in a sectional view.

### DETAILED DESCRIPTION OF PREFERRED EMBODIMENTS

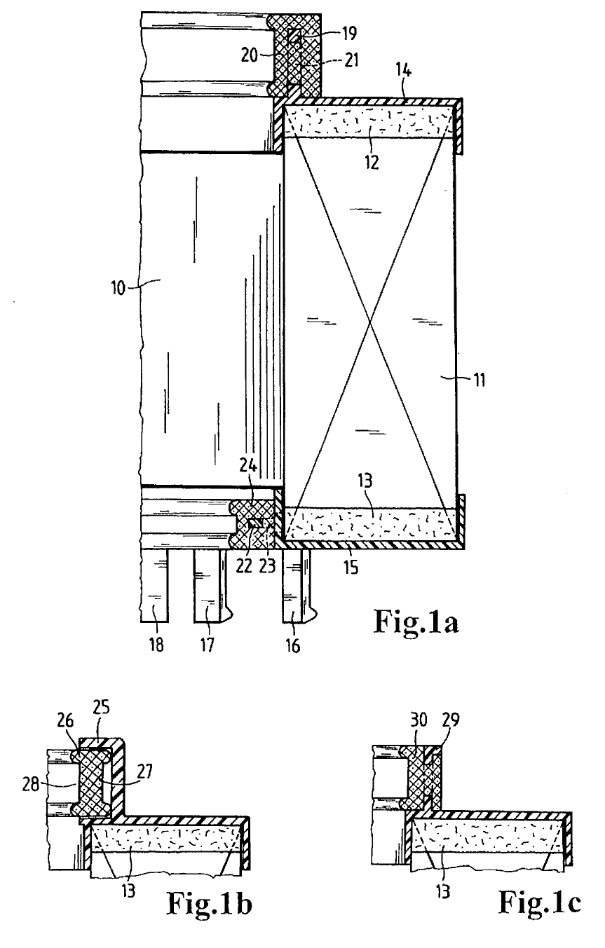

FIG. 1a shows a sectional illustration of a filter element, comprising an annular support body 10, and a filter medium 11, particularly a filter paper, which is folded in a zigzag shape and positioned on the support body. This filter medium is sealed on its axial end faces using plastic films 12, 13. The plastic films are enclosed by end disks 14, 15 made of a thermoplastic material. End disk 15 is provided with snap elements 16, 17, 18 located thereon by which the filter element may be latched onto a carrier, not shown.

End disk 14 is provided with an axially directed web 19. A seal, particularly an elastomer seal 20, is extrusion coated onto this web in an interlocking manner. Web 19 has radial openings 21, which are also filled up during the process of producing the seal and therefore form a reliable connection between the web and the elastomer seal.

A radially inwardly directed web 22 is provided on the opposite end disk 15. This web is also provided with openings 23 and is enclosed by an elastomer seal 24.

FIG. 1b shows a variant of a seal carrier 25. This web encloses a profiled seal 26, which is therefore also positioned in an interlocking manner in the seal carrier. Seal carrier 25 is radially yielding and may therefore deflect in the event of very high seal pressures. In addition, profiled seal 26 is provided with recesses 27, 28 and therefore displays good elastic properties.

FIG. 1c shows a further seal carrier variant. The seal carrier is a web 29, which also is provided with openings so that profiled seal 30 may be reliably attached.

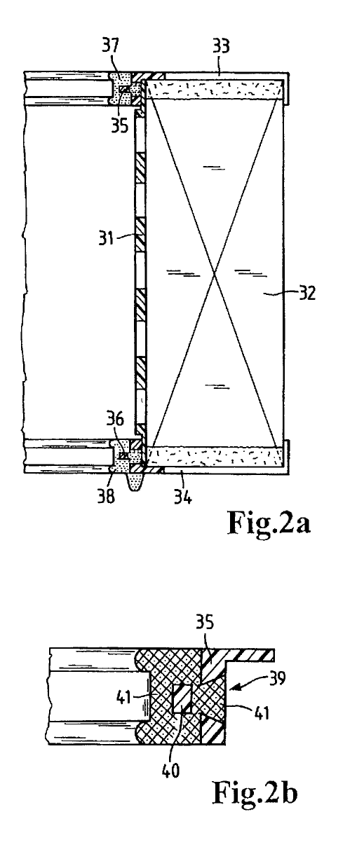

FIG. 2a shows a partial section of a support body 31, which again supports a filter element 32. The end faces of the filter element are sealed by plastic end disks 33, 34 attached via appropriate adhesive bonds. The plastic end disks carry radially directed seal seats 35, 36. These seal seats are in turn extrusion coated with elastomer seals 37 and 38, respectively.

FIG. 2b shows a detailed illustration of seal seat 35, which has openings 39 distributed around its circumference and webs 40 delimiting the openings. During extrusion coating of the webs and the openings with elastomeric sealing material 41, a interlocking attachment between seal seat 35 and the sealing material results. If webs 40 are appropriately designed to yield resiliently, they may contribute improved radial elasticity to the seal.

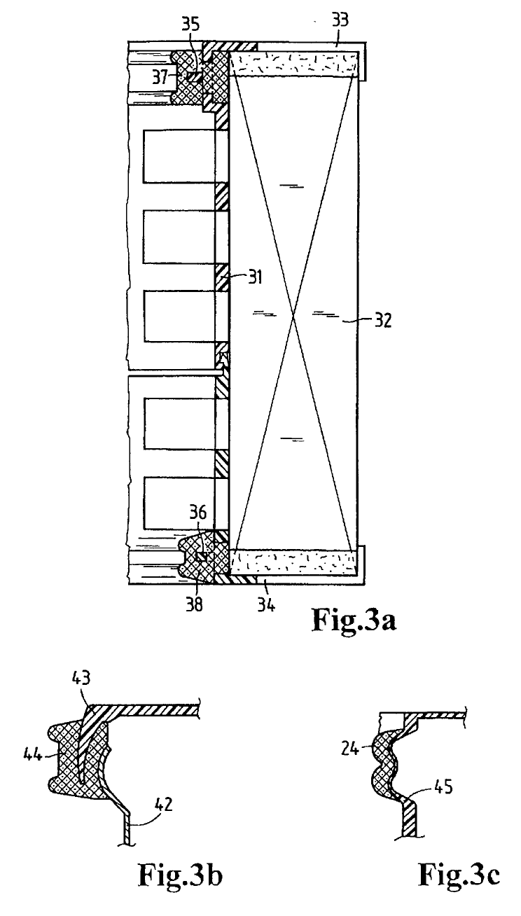

FIG. 3a shows a partial section of a support body 31 which again supports a filter element 32. The axial end faces of the filter element are sealed by plastic end disks 33, 34 attached via appropriate adhesive bonds. The plastic end disks carry radially directed seal seats 35, 36. These seal seats are extrusion coated with seals 37 and 38, respectively.

FIG. 3b is a detailed illustration of a seal seat, comprising two tongues 42, 43 which pivot freely on one side. Elastomer seal 44 is disposed on these tongues. Constructing the seal carrier in the form of such tongues has the advantage that the seal can have a very high radial elasticity.

FIG. 3c shows a seal carrier 45, which is designed as a membrane and also has radially elastic properties. Elastomer seal 24 is applied to this seal carrier using the two-component injection molding method.

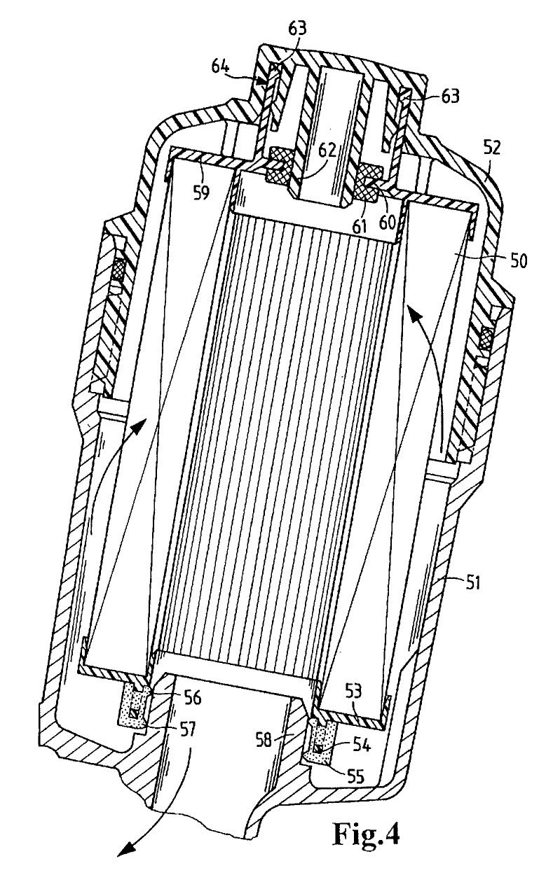

FIG. 4 shows a sectional illustration of a complete filter system. A filter element 50 is positioned in a housing 51, and this housing 51 is provided with a cover 52. Filter element 50 has a lower end disk 53. This end disk is provided with a concentric web 54, which is extrusion coated with an elastomer material 55. The seal formed by elastomer 55 has a first seal edge 56 and a second seal edge 57, which press against a connection sleeve 58.

An end disk 59 is located on the opposite end of filter element 50. This end disk is provided with a radially inwardly directed web 60. This web is also extrusion coated using an elastomer material 61 and forms a seal relative to cover 52 via cylindrical wall 62. End disk 59 is provided with catch elements 63 which engage in catch openings 64 on the cover 52 and thus provide a removable connection between cover 52 and the filter element 50. Cover 52 is affixed to housing 51 via a screw thread. When the cover is opened, i.e., when the cover is unscrewed and removed from the housing, the attached filter element is also pulled out of the housing. After the cover has been completely removed, the filter element may be unclipped from the cover and a new filter element may be inserted into the housing.

It is also possible, of course, to arrange a pressure relief valve or bypass valve inside cylindrical sealing element 62, however, this is generally known and will not be described here in more detail.

The foregoing description and examples have been set forth merely to illustrate the invention and are not intended to be limiting. Since modifications of the described embodiments incorporating the spirit and substance of the invention may occur to persons skilled in the art the invention should be construed broadly to include all variations falling within the scope of the appended claims and equivalents thereof.

What is claimed is:

1. A filter element comprising an annular support body, a filter medium positioned on the annular support body, a pair of end disks each positioned on a respective end face of the filter medium and attached to the filter medium, and at least one seal carrier on the support body in the vicinity of a respective one of said end disks, said seal carrier being radially elastic and having a seal affixed thereto in an interlocking manner.

2. A filter element according to claim 1, wherein said filter element is a liquid filter.

3. A filter element according to claim 1, wherein said filter medium is a filter paper pleat folded in a zigzag shape.

4. A filter element according to claim 1, wherein said seal is an elastomer seal.

5. A filter element according to claim 1, wherein said end disks are attached by gluing or by welding to the filter medium.

6. A filter element according to claim 1, wherein said seal carrier comprises two intermeshing tongues which each pivot on one side.

7. A filter element according to claim 1, wherein the seal carrier is constructed as a membrane.

8. A filter element according to claim 1, said seal comprises a region which forms an axial seal.

9. A filter element according to claim 1, wherein at least one of the end disks is made of nitrile rubber and encloses the support body on the face.

10. A fluid filter system comprising a filter housing, an inlet for unfiltered fluid, an outlet for clean fluid, a connection sleeve positioned on the clean fluid outlet, and a filter element removably attached to the connection sleeve and positioned in the filter housing such that fluid must flow through the filter element to pass from said inlet to said outlet; wherein at least one radially elastic seal carrier is provided on the support body in the vicinity of a respective one of the end disks, said seal carrier having a seal attached thereto in an interlocking manner, and wherein the seal carrier is radially elastic.

11. A filter system according to claim 10, wherein said fluid is a liquid.

12. A filter system according to claim 10, wherein said seal is an elastomer seal.
